(19) United States
(12) Patent Application Publication
(10) Pub. No.: US 2015/0352959 A1
(43) Pub. Date: Dec. 10, 2015

(54) NON-RAIL-BOUND VEHICLE

(71) Applicant: SIEMENS AKTIENGESELLSCHAFT, MUENCHEN (DE)

(72) Inventors: FLORIAN BUEHS, BERLIN (DE); JUERGEN FRANCKE, BERLIN (DE); FRANK GERSTENBERG, BERLIN (DE); GOERAN KEIL, BERLIN (DE); ANDRE TOLKSDORF, BERLIN (DE); FRANK VOSS, BERLIN (DE)

(21) Appl. No.: 14/735,320

(22) Filed: Jun. 10, 2015

(30) Foreign Application Priority Data
Jun. 10, 2014 (DE) 102014211031.9

(51) Int. Cl. B60L 5/08; B60L 9/00; B60L 5/12; B60L 5/36; B60L 5/24

(52) U.S. Cl. CPC B60L 5/08; B60L 5/36; B60L 5/24; B60L 5/12; B60L 9/00; B60L 2200/36

(57) ABSTRACT

A non-rail-bound, electrically driven vehicle contains a vehicle body having a vehicle width and a current collector for feeding traction energy from an overhead line. The current collector has two support brackets, an apex member connected to overhead-contact-line-side ends of the support brackets and lying transversely to a longitudinal axis, and two rockers mounted so as to rotate about an apex member axis. The support brackets are articulated at their vehicle-side ends to the vehicle body such that the rockers can be adjusted in height between a lowered idle position and a raised contact position and can be transversely moved between two lateral deflected positions. Accordingly, the rockers can be moved transversely independently of one another, wherein it is possible to adjust a current collector width so that it is less than the vehicle width. Therefore the vehicle can also be licensed for operation outside electrified routes.

### CROSS-REFERENCE TO RELATED APPLICATION

This application claims the priority, under 35 U.S.C. §119, of German application DE 10 2014 211 031.9, filed Jun. 10, 2014; the prior application is herewith incorporated by reference in its entirety.

### BACKGROUND OF THE INVENTION

### Field of the Invention

The invention relates to a non-rail-bound, electrically driven vehicle.

Such a vehicle is known from published, non-prosecuted German patent application DE 10 2011 076 623 A1, corresponding to U.S. patent publication No. 2014/0097054. It contains a vehicle body having a vehicle width and a current collector for feeding traction energy from a two-pole overhead contact line. The current collector has two support brackets, the ends of which on the overhead contact line side are connected in an articulated manner to an apex member lying transversely to a vehicle longitudinal axis. The apex member bears two rockers mounted so as to rotate about an apex member axis with contact strips. At their vehicle-side ends the support brackets are articulated to the vehicle body such that the rockers can be adjusted in height between a lowered idle position and a raised contact position and can be transversely moved between two lateral deflected positions.

Because of the default safety clearance between the contact wires formed as conductor pairs of the overhead contact line and running essentially parallel to one another, as well as the default minimum length of the contact strips for the formation of a sufficient working area for the contact between contact strip and contact wire, the width of the known current collector is significantly larger than the officially permitted vehicle width of the vehicle body. Special authorization may be given here for travel on an electrified route, such as in the right-hand lane of a federal highway equipped with an overhead contact line. The known vehicle suffers from the disadvantage that because of the outsize width of the current collector it exceeds the overall width permitted for conventional road traffic and hence cannot be operated there.

In the field of electric rail traffic, rail-bound vehicles with current collectors are known, whose width can be modified in order to reduce their clearance gauge for running in tunnels, or in international rail traffic to be able to satisfy the requirements in different European countries for rocker widths and contact strip curvatures.

Thus a current collector consisting of a bracket and pantograph frame is known from published, non-prosecuted German patent application DE 353196 A, whose width can be adjusted transversely to the longitudinal axis of the vehicle. In a first embodiment the current collector can be placed on a frame permanently attached to the vehicle so as to rotate about a perpendicular axis. Thanks to the rotation which is driven by a gear rack moved by an air pressure cylinder, the current collector can be brought from its laterally projecting position into a position suitable for the tunnel profile. In a second embodiment the collector shoe of the current collector is extended by cams at both sides by joints, with the free ends of the cams being connected by two guide rods to the two upper struts of the pantograph frame using ball joints. In the normal position the cams form precise extensions of the central collector shoe, so that the current collector has its greatest width in this position. When the position of the contact wire in the tunnel is low, the lateral cams are retracted inward by pressing down the pantograph frame. In a third embodiment the ends of the cams are not connected to the associated guide rods by joints, but by rings or loops, in which they can move freely.

German utility model DE 93 04 251 U1 discloses a current collector for an in particular rail-bound vehicle with a rocker which contains a fixed collector shoe and two collector shoes which can be adjusted in respect of these and perpendicular to the longitudinal axis of the vehicle. The adjustable collector shoes are arranged so as to overlap with the fixed collector shoe when viewed in the train direction.

Published, non-prosecuted German patent application DE 199 14 566 A1 shows a current collector system for contacting with a contact wire of an overhead contact line. It contains a retaining device which is mounted on an electrically operated rail vehicle and can be adjusted in height for a rocker frame. Brackets and contact strips are provided on the rocker frame and are attached using interface modules. The separate contact strips and brackets, each of which is associated with a vehicle side, can be adjusted independently of one another transversely to the direction of travel. The interface modules are for example implemented by pneumatically or hydraulically activatable cylinders.

Published, non-prosecuted German patent application DE 10 2011 013 267 A1 proposes a current collector for electrically driven vehicles, in which a current collector rocker has at least one contact strip arranged transversely to the direction of travel. The contact strip in turn has a fixed collector shoe and two collector shoes that can be moved relative thereto in opposite directions, which are arranged on brackets arranged transversely to the direction of travel. The contact strip and the brackets have pantograph horns on their ends. In the retracted position of the brackets the bracket pantograph horns do not project laterally over the clearance gauge delimited by the fixed contact strip and the contact strip pantograph horns.

These known current collectors for rail-bound vehicles are configured for contacting a single-pole overhead contact line, with the rocker for height adjustment being supported by a pantograph-type frame or semi-frame and having a defined lateral position to the contact wire. They cannot be transferred to a non-rail-bound road vehicle with a current collector, whose two rockers each contact a contact wire of the two-pole overhead contact line while laterally equalizing driving inaccuracies in the traffic lane.

### SUMMARY OF THE INVENTION

The object of the invention is therefore to provide a generic vehicle which can also be authorized for operation outside electrified vehicle routes.

The object is achieved by a vehicle of the type mentioned in the introduction with the features specified in the main claim. According to this a non-rail-bound electrically driven vehicle, for example a heavy goods vehicle for road traffic, contains a vehicle body with a predefined vehicle width. Furthermore it contains a current collector for feeding traction energy from a two-pole overhead contact line. The current collector has two support brackets with ends on the overhead contact line side and on the vehicle side. Furthermore it has an apex member which is connected in an articulated manner to the overhead-contact-line-side ends of the support brackets and which lies transversely to a vehicle longitudinal axis. In addition the current collector has two rockers mounted so as to rotate about an apex member axis with contact strips. In this case the support brackets are articulated at their vehicle-side ends to the vehicle body such that the rockers can be adjusted in height between a lowered idle position and a raised contact position and can be transversely moved between two lateral deflected positions. According to the invention the rockers can be moved transversely independently of one another, it being possible to adjust a width of the current collector so that it is less than the vehicle width, at least in the idle position of the current collector. This means the width of the current collector can be adjusted between a wide operating position, in which the support brackets can be swiveled laterally in parallel to one another, and a narrow idle position, in which the support brackets are mutually swiveled toward one another. In the idle position the rockers do not project laterally out over the vehicle body. Thus the overall width of the vehicle can adhere to the vehicle width permitted for road traffic outside electrified lanes, by moving the current collector into its lowered idle position with a small current collector width. The ability for the support brackets to move transversely independently of one another can be achieved thanks to corresponding separate activation of the torque motors with high torques effecting the swiveling motion of the support brackets.

In an advantageous embodiment of the inventive vehicle the apex member has two apex member sections, each supporting one of the rockers, which are connected by way of a joint so as to be able to move relative to one another in the direction of the apex member axis. This not only ensures the mechanical stability of the current collector with the support brackets connected at their overhead-contact-line-side ends by way of the apex member, but also the connection of the first and second apex member sections by way of the joint permits a translatory degree of freedom of movement of the apex member sections. Swiveling the support brackets toward one another or away from one another means the telescopic brackets are pushed into one another or pulled out of one another by the joint in the manner of a telescope, as a result of which the rockers are moved toward or away from one another. Advantageously the joint can permit a further rotary degree of freedom of movement of the apex member sections, so that these can be twisted relative to one another about the apex member axis. This means the apex member sections can participate in the rotary motion of the rocker supported by them in each case, regardless of the other one in each case.

In a preferred embodiment of the inventive vehicle each of the rockers has at least one contact strip which lies parallel to the apex member and which are arranged in alignment with one another and at their lateral ends have inner and outer pantograph horns which are bent downward, at least one of the inner pantograph horns being bent forward or backward. The pantograph horns stop a contact wire from getting under the contact strips in the event of relatively large lateral deflections of the support brackets or in the event of a lateral drift of the contact wires caused by a wind load; instead they are returned by way of a pantograph horn to the working area of a contact strip. To this end the pantograph horns form the laterally downward-bent ends of the contact strips, and in particular the spacing of the outer pantograph horns determines the width of the current collector. When the support brackets are swiveled into the idle position, the rockers can be moved toward one another until the aligned contact strips meet. So that the width of the current collector can be reduced in the idle position, and to stop two inner pantograph horns from meeting, at least one is bent forward or backward, in order to make room for the other one. The effect can be improved if the other inner pantograph horn in each case is bent backward or forward contrary to the first one.

Other features which are considered as characteristic for the invention are set forth in the appended claims.

Although the invention is illustrated and described herein as embodied in a non-rail-bound vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, plan view of a vehicle with a current collector in an operating position according to the invention; and

FIG. 2 is a plan view of the vehicle from FIG. 1 with the current collector in an idle position.

### DETAILED DESCRIPTION OF THE INVENTION

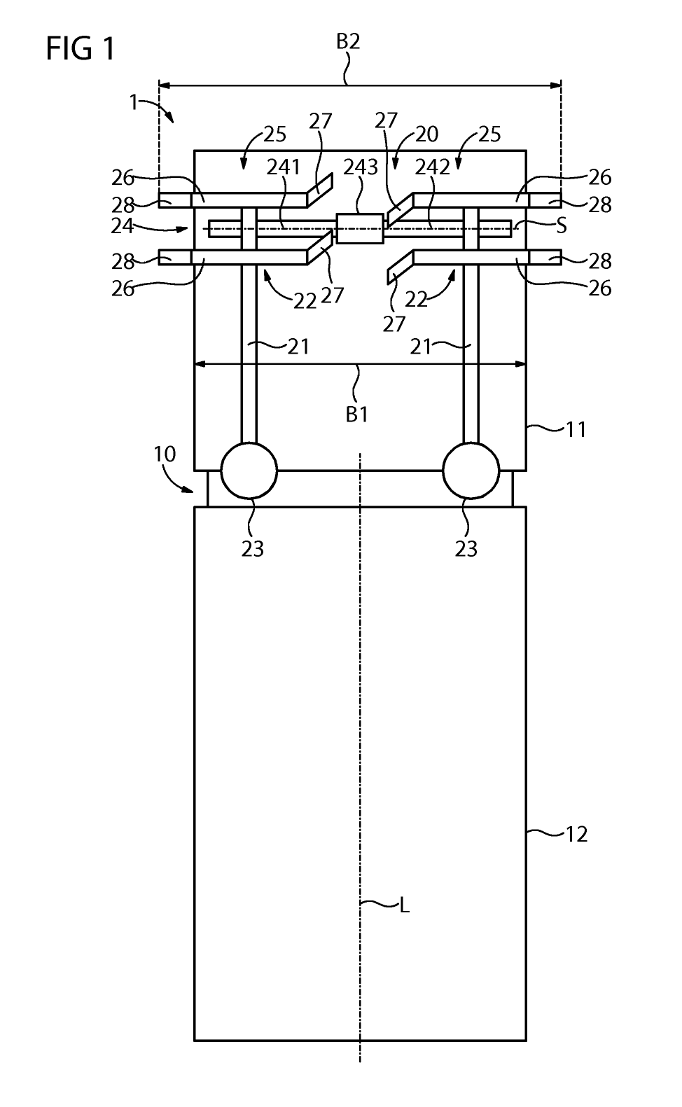

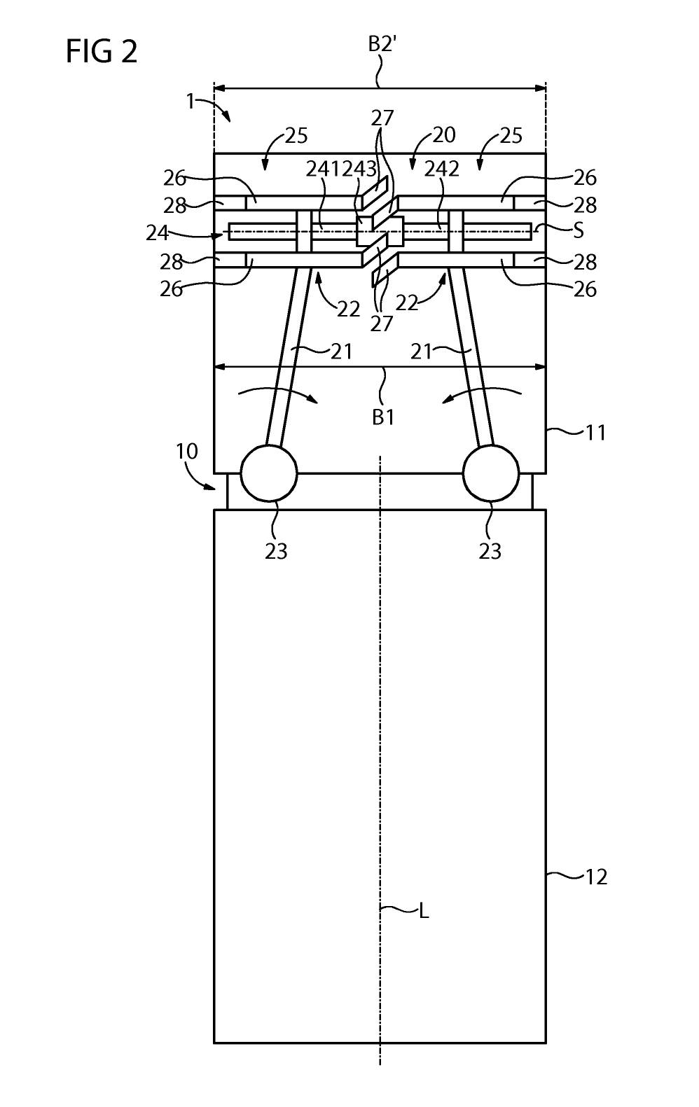

Referring now to the figures of the drawings in detail and first, particularly to FIGS. 1 and 2 thereof, there is shown a non-rail-bound, electrically driven vehicle 1 for example a heavy goods vehicle for road traffic and contains a non-illustrated electric or diesel-electric traction drive. The vehicle 1 contains a vehicle body 10 determining a vehicle width B1 with a driver's cab 11 and a loading structure 12 arranged behind this, which are supported on a non-illustrated vehicle frame. The vehicle 1 further contains a current collector 20 connected to the vehicle frame for feeding traction energy from a non-illustrated two-pole overhead contact line which has two contact wires configured as conductor pairs. The contact wires and catenary wires holding them by hangers form a catenary system which is held on jibs projecting over the route from masts and is for example braced by wheel tensioners. An electrified route, for example the right-hand lane of a highway, is divided into feeder sections electrically separate from one another, which in each case are supplied with electrical energy by a substation.

The current collector 20 has two support brackets 21, which on their ends 22 on the overhead contact line side are connected in an articulated manner to an apex member 24 lying transversely to a vehicle longitudinal axis L. The vehicle longitudinal axis L points in a forward travel in the direction of travel of the vehicle 1. The current collector 20 further has two rockers 25 which are mounted so as to rotate about an apex member axis S and which each have a pair of contact strips 26 arranged in series in the direction of travel and running parallel to the apex member axis S. Vehicle-side ends 23 of the support brackets 21 are articulated to the vehicle body 10. Each of these articulations is configured to be double-articulated and has a horizontal tipping axis and a vertical swivel axis. Each support bracket 21 can be rotated about its horizontal tipping axis such that the height of its overhead-contact-line-side end 22 can be adjusted between a lowered idle position, in which the support bracket 21 points approximately horizontally forward over the driver's cab 11, and a raised operating position, in which the contact strips 26 of the respective contact wire contact extend outward beyond the body. The height adjustment can be driven by a pneumatic cylinder or muscle. In addition each support bracket 21 can rotate about its vertical swivel axis such that its overhead-contact-line-side end 22 can be moved transversely between two lateral deflection positions. In the raised operating position the support brackets 21 are aligned in parallel according to FIG. 1 and swivel synchronously in order to execute a transverse movement of the rockers 25. The transverse movement is for example effected by torque motors which are activated by a non-illustrated control system. The control system determines the manipulated variable for the transverse movement as a function of continuously acquired actual values of a sensor device, which determines the lateral position of the vehicle 1 relative to the overhead contact line. This ensures that the contact strips 26 can always be contacted by the contact wires in a predefined working area, even if the vehicle 1 is not articulated precisely in line with the track. The current collector 20 has a current collector width B2 in the operating position which is larger than the vehicle width B1 of the vehicle 1.

In overtaking and evasive maneuvers, in particular when leaving the electrified route, the current collector 20 is automatically or manually lowered into its idle position. So that on non-electrified routes the vehicle 1 does not exceed its authorized vehicle width B1, its width is inventively reduced before or while the current collector 20 is lowered into its idle position. To this end the rockers 25 can be transversely moved independently of one another and are moved toward one another in the direction of the vehicle longitudinal center such that the current collector width B2′ is less in the lowered idle position than the vehicle width B1. In the idle position the support brackets 21 are swiveled toward one another according to FIG. 2 and enclose an acute angle. To this end, in the exemplary embodiment illustrated, the apex member 24 is divided into a first apex member section 241 and a second apex member section 242, which are connected to one another by way of a joint 243. The joint 243 permits a linear degree of freedom of movement, so that the apex member sections 241 and 242 can be telescopically pushed into one another and pulled out again from one another. Each contact strip 26 has an inner pantograph horn 27 at its lateral end facing toward the vehicle longitudinal center and an outer pantograph horn 28 at its lateral end facing away from the vehicle longitudinal center 25. The pantograph horns 27 and 28 are bent obliquely downward and are known per se. The contact strips 26 of adjacent rockers 25 are arranged in alignment with one another. To be able to move the rockers 25 closer to the vehicle longitudinal center, the inner pantograph horns 27 of the one rocker 25 are bent obliquely forward, while the inner pantograph horns 27 of the other rocker 25 are bent obliquely backward.

Since the current collector width B2′ in the idle position is less than the vehicle width B1, a continuous wind deflector element can be used on the driver's cab 11, which has a bent front part and two side parts linking thereto without interruption.

1. A non-rail-bound, electrically driven vehicle, comprising:
a vehicle body having a vehicle width; and
a current collector for feeding traction energy from a two-pole overhead contact line, said current collector having two support brackets with overhead-contact-line-side ends and vehicle-side ends, an apex member connected in an articulated manner to said overhead-contact-line-side ends of said support brackets and lying transversely to a vehicle longitudinal axis, and two rockers mounted so as to rotate about an apex member axis with contact strips, wherein said vehicle-side ends of said support brackets are articulated on said vehicle body such that said rockers being adjusted in height between a lowered idle position and a raised contact position and being transversely moved between two lateral deflection positions, said rockers being transversely moved independently of one another, wherein at least in the idle position of said current collector a current collector width can be adjusted which is less than said vehicle width.

2. The vehicle according to claim 1, wherein said apex member has a joint and two apex member sections, each of said two apex member sections supporting one of said rockers, said two apex member sections being connected so as to move relative to one another by way of said joint in a direction of the apex member axis.

3. The vehicle according to claim 1, wherein each of said rockers has at least one of said contact strips lying parallel to said apex member and said contact strips are arranged in alignment with one another and at their lateral ends have inner and outer pantograph horns which are bent downward, wherein at least one of said inner pantograph horns is bent forward or backward.
